(19) United States
(12) Patent Application Publication
(10) Pub. No.: US 2019/0315465 A1
(43) Pub. Date: Oct. 17, 2019

(54) UNMANNED VEHICLE, CONTROL SYSTEM AND METHOD THEREOF, AND ELECTRONIC SPEED CONTROL AND CONTROL METHOD THEREOF

(71) Applicant: SZ DJI TECHNOLOGY CO., LTD., Shenzhen (CN)

(72) Inventors: Wangqi LIU, Shenzhen (CN); Qiu LAN, Shenzhen (CN); Changxing ZHOU, Shenzhen (CN)

(21) Appl. No.: 16/456,722

(22) Filed: Jun. 28, 2019

Related U.S. Application Data
(63) Continuation of application No. PCT/CN2016/112691, filed on Dec. 28, 2016.

(51) Int. Cl. B64C 39/02; G05D 1/00

(52) U.S. Cl. CPC B64C 39/024; G05D 1/0011; B64C 2201/108; B64C 2201/146; B64C 2201/027

(57) ABSTRACT

A control system includes a control device, a plurality of electronic speed controls (ESCs) communicating and sharing status information with each other, and a plurality of motors each coupled to one of the plurality of ESCs. The control device can generate a control signal based on control instructions received by a transceiver. Each of the plurality of ESCs can generate a driving signal based on the control instructions. The plurality of motors can be driven by the driving signal generated by the one of the plurality of ESCs.

### CROSS-REFERENCE TO RELATED APPLICATION

This application is a continuation application of International Application No. PCT/CN2016/112691, filed on Dec. 28, 2016, the entire content of which is incorporated herein by reference.

### TECHNICAL FIELD

The present disclosure relates to an unmanned vehicle, and in particularly, to a control system and control method for the unmanned vehicle, and an electronic speed control and a control method thereof.

### BACKGROUND

Because unmanned vehicles, also referred to as “driverless vehicles,” do not need humans to drive, and can enter various environments where humans are difficult to reach, they are widely used in various applications such as monitoring, reconnaissance, exploration and so on. An unmanned vehicle includes a power system to provide lift. The powder system generally includes one or a plurality of motors and propellers that are driven by the motor to rotate. The motor is typically controlled by an electronic speed control (ESC). The ESC can receive a throttle control signal of a transceiver or a flight control system and generate a pulse width modulation (PWM) signal to drive the rotation of the motor according to the throttle control signal received.

A conventional multi-rotor unmanned vehicle includes multiple power mechanisms, and each power mechanism includes a plurality of ESCs, motors, and rotors. Each ESC receives the throttle control signal from the flight control system of the unmanned vehicle, and accordingly control the rotation of the corresponding motor. There is usually no mutual communication mechanism between the plurality of ESCs, so each ESC cannot know statuses of other ESCs. For example, when problems occur, e.g., one of the plurality of ESCs has a hardware failure, a motor has a blocked rotation, or a rotor has a paddle shooting, etc., the remaining part of the power mechanism may not know. Therefore, the flight of the unmanned vehicle is not stable, resulting in a high possibility of damage.

### SUMMARY

In accordance with the disclosure, there is provided a control system including a control device, a plurality of electronic speed controls (ESCs) communicating and sharing status information with each other, and a plurality of motors each coupled to one of the plurality of ESCs. The control device can generate a control signal based on control instructions received by a transceiver. Each of the plurality of ESCs can generate a driving signal based on the control instructions. The plurality of motors can be driven by the driving signal generated by the one of the plurality of ESCs.

Also in accordance with the disclosure, there is provided a control method. The control method includes generating, by a control device, a control signal based on control instructions received by a transceiver; transmitting, by the control device, the control signal to one or more of a plurality of electronic speed controls (ESCs); determining, by the control device, whether the plurality of ESCs are operating abnormally based on status information of the plurality of ESCs; controlling, by the control device, the plurality of ESCs to stop operating in response to detecting that at least one of the plurality of the ESCs is operating abnormally.

### DESCRIPTION OF THE DRAWINGS

FIG. 1 is a schematic structural view of an unmanned vehicle according to an embodiment of the present disclosure.

FIG. 2 is a block diagram of a control system for an unmanned vehicle according to an embodiment of the present disclosure.

FIG. 3 is a block diagram of an electronic speed control (ESC) according to an embodiment of the present disclosure.

FIG. 4 is a schematic connection diagram showing status sharing among ESCs according to an embodiment of the present disclosure.

FIG. 5 is a schematic connection diagram showing status sharing among ESCs according to another embodiment of the present disclosure.

FIG. 6 is a schematic connection diagram showing status sharing among ESCs according to another embodiment of the present disclosure.

FIG. 7 is a flowchart of a control method for an unmanned vehicle according to an embodiment of the present disclosure.

FIG. 8 is a flowchart of a control method for an unmanned vehicle according to another embodiment of the present disclosure.

FIG. 9 is a flowchart of a control method for an unmanned vehicle according to another embodiment of the present disclosure.

TABLE 1
REFERENCE NUMERALS FOR MAIN COMPONENTS

| | |
|---|---|
| Unmanned vehicle | 1 |
| Vehicle body | 10 |
| Power mechanism | 12 |
| Sensing system | 14 |
| Transceiver | 16 |
| Carrier | 17 |
| Load | 18 |
| Terminal | 110 |
| Unmanned vehicle control system | 2 |
| Control device | 20 |
| Electronic speed control (ESC) | 22 |
| Motor | 24 |
| First ESC | 220 |
| Second ESC | 222 |
| Third ESC | 224 |
| Forth ESC | 226 |
| ESC controller | 2200 |
| Power port | 2202 |
| Motor port | 2204 |
| Control signal port | 2206 |
| Status port | 2208 |

### DETAILED DESCRIPTION

Technical solutions of the present disclosure will be described with reference to the drawings. It will be appreciated that the described embodiments are some rather than all of the embodiments of the present disclosure. Other embodiments conceived by those having ordinary skills in the art on the basis of the described embodiments without inventive efforts should fall within the scope of the present disclosure.

As used herein, when a first component is referred to as “fixed to” a second component, it is intended that the first component may be directly attached to the second component or may be indirectly attached to the second component via another component. When a first component is referred to as “connected” to a second component, it is intended that the first component may be directly connected to the second component or may be indirectly connected to the second component via a third component between them. When a first component is referred to as “disposed” to a second component, it is intended that the first component may be directly connected to the second component or may be indirectly connected to the second component via a third component between them. The terms “perpendicular,” “horizontal,” “left,” “right,” and similar expressions used herein are merely intended for description.

Unless otherwise defined, all the technical and scientific terms used herein have the same or similar meanings as generally understood by one of ordinary skill in the art. As described herein, the terms used in the specification of the present disclosure are intended to describe example embodiments, instead of limiting the present disclosure. The term “and/or” used herein includes any suitable combination of one or more related items listed.

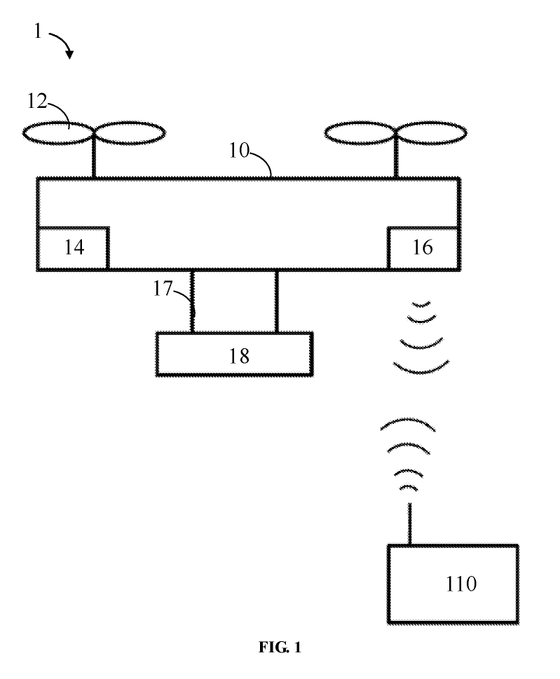

FIG. 1 shows an unmanned vehicle 1 according to an embodiment of the present disclosure. The unmanned vehicle 1 can be used in any suitable environment, for example, in the air (e.g., rotorcrafts, fixed-wing aircrafts, or hybrid fixed-wing and rotor aircrafts), in water (e.g., boats or submarines), on the ground (e.g., motorcycles, cars, trucks, buses, or trains, etc.), in space (e.g., space shuttles, satellites, or detectors), underground (e.g., subways), or any combination of the above environments. In some embodiment of the present disclosure, the unmanned vehicle 1 may be a rotorcraft, which may include a single rotor, dual rotors, three rotors, four rotors, six rotors, or eight rotors, etc. An unmanned aerial vehicle is used as an example of the unmanned vehicle 1 to describe embodiments of the present disclosure in detail.

As shown in FIG. 1, the unmanned vehicle 1 includes a power mechanism 12, a sensing system 14, and a transceiver 16. In some embodiments, the unmanned vehicle 1 also includes a carrier 17 and a load 18. In some embodiments, the carrier 17 may be omitted, and the load 18 may be directly mounted to the unmanned vehicle 1 without the carrier 17. The power mechanism 12 may include, but is not limit to, one or more of a rotor, a propeller, a blade, an engine, a motor, a wheel set, a shaft, a magnet, and a nozzle. In some embodiments, the unmanned vehicle 1 may include one or more power mechanisms 12. If the unmanned vehicle 1 includes multiple power mechanisms 12, the multiple power mechanisms 12 can be of the same type or different types. In some embodiments, the one or more power mechanisms 12 can enable the unmanned vehicle 1 to vertically take off or land on a surface without any horizontal movement required (e.g., no requirement of sliding on the runway). In some embodiments, the one or more power mechanisms 12 may operate to cause the unmanned vehicle 1 to hover over a designated position and orientation.

For example, the unmanned vehicle 1 may include a plurality of horizontally-oriented rotors configured to provide a lift and thrust for the aircraft. The plurality of horizontally-oriented rotors may operate to enable the unmanned vehicle 1 to vertically take-off, vertically land, and/or hover. In some embodiments, one or more horizontally-oriented rotors may rotate clockwise or and another one or more horizontally-oriented rotors may rotate counter-clockwise. For example, the number of rotors that rotate clockwise may equal the number of the rotors that rotate counter-clockwise. The rotational speed of each horizontally-oriented rotor may be varied independently to control the lift and/or thrust generated by the rotor, so as to adjust the spatial orientation, velocity, and/or acceleration of the unmanned vehicle 1 (e.g., relative degrees of freedom of three-dimensional translation and degrees of freedom of three-dimensional rotation).

The sensing system 14 may include one or more sensors that can sense the spatial orientation, velocity, and/or acceleration of the unmanned vehicle 1 (e.g., relative degrees of freedom of three-dimensional translation and degrees of freedom of three-dimensional rotation). The one or more sensors can include global positioning system (GPS) sensors, motion sensors, inertial sensors, proximity sensors, and/or image sensors. Data generated by the sensing system 14 may be used to control the spatial orientation, velocity, and/or orientation of the unmanned vehicle 1 (e.g., using a suitable processing unit and/or a control module as described below). In some embodiments, the sensing system 14 may be configured to provide information about the surrounding environment of the unmanned vehicle 1, such as weather conditions, proximities to potential obstacles, locations of geographic features, and/or locations of artificial structures, etc.

The transceiver 16 may communicate with a terminal 110 wirelessly. In some embodiments, the communication may be a two-way communication, and the terminal 110 provides control instructions to and receives information from one or more of the unmanned vehicle 1, the carrier 17, and the load 18. The signal received by the terminal 110 from one or more of the unmanned vehicle 1, the carrier 17, and the load 18 includes position and/or movement information of the unmanned vehicle 1, the carrier 17, and/or the load 18 and data generated by the load 18, e.g., image data generated by a camera. In some cases, the control instructions from the terminal 110 may include relative positions, movements, and controls of the unmanned vehicle 1, the carrier 17, and/or the load 18. For example, the control instructions may change the position and/or direction of the unmanned vehicle 1 (e.g., by controlling the one or more power mechanisms 12) or cause the load 18 to move relative to the unmanned vehicle 1 (e.g., by controlling the carrier 17). The control instructions from the terminal 110 may control the operation of the load 18 (a camera or other image acquisition device), e.g., acquiring a static or dynamic image, zooming in or out of lens, turning on or off, switching image modes, changing an image resolution, focusing, changing a field depth, changing an exposure time, and/or changing a view or a view angle, etc. In some cases, communication information from the unmanned vehicle 1, the carrier 17, and/or the load 18 may include information from one or multiple sensors (e.g., the sensing system 14 or the load 18). The communication information may be information from one sensor or multiple sensors of different types, such as GPS sensors, motion sensors, inertial sensors, proximity sensors, and/or image sensors. The information may be information about the orientation (e.g., the position and direction), the movement, or the acceleration of the unmanned vehicle 1, the carrier 17, and/or the load 18. The information of the load 18 may include data generated by the load 18 by sensing or status information of the load 18. The control instructions provided and transmitted by the terminal 110 may be configured to control the status of the unmanned vehicle 1, the carrier 17, and/or the load 18. In some embodiments, the carrier 17 and/or the load 18 may also respectively include a transceiver that communicates with the terminal 110, so that the terminal 100 can communicate with and control the unmanned vehicle 1, the carrier 17, and/or the load 18 independently.

The unmanned vehicle 1 may also include an unmanned vehicle control system. The unmanned vehicle control system can control the one or more power mechanisms 12 to provide the lift and thrust for the unmanned vehicle 1, based on the control instructions sent by the transceiver 16 and the sensing data from the sensing system.

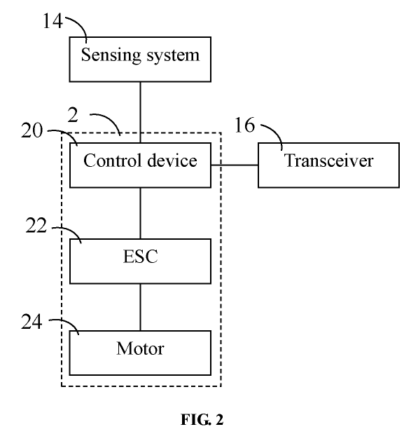

FIG. 2 is a block diagram showing an internal structure of an unmanned vehicle control system 2 according to an embodiment of the present disclosure. The unmanned vehicle control system 2 includes a control device 20, an electronic speed control (ESC) 22, and a motor 24.

The control device 20 may be configured to receive control instructions received and transmitted by the transceiver 16 and the sensing data from the sensing system 14 to generate the control instructions. The control instructions can control the one or more power mechanism 12 of the unmanned vehicle 1 to adjust the orientation, velocity, and/or acceleration of six-degrees freedom of the unmanned vehicle 1. In some embodiments, the control instructions can also control one or more of the carriers 17, the load 18 and the sensing system 14. In some embodiments, the unmanned vehicle 1 is an unmanned aerial vehicle, and the control device 20 is a flight control system of the unmanned aerial vehicle.

The ESC 22 is configured to receive the control instructions from the control device 20 and generate a pulse width modulation (PWM) signal for driving the motor 24 according to the control instructions. The motor 24 can be driven by the PWM signal to rotate to drive the one or more power mechanism 12 to rotate, thereby providing lift and thrust for the unmanned vehicle 1.

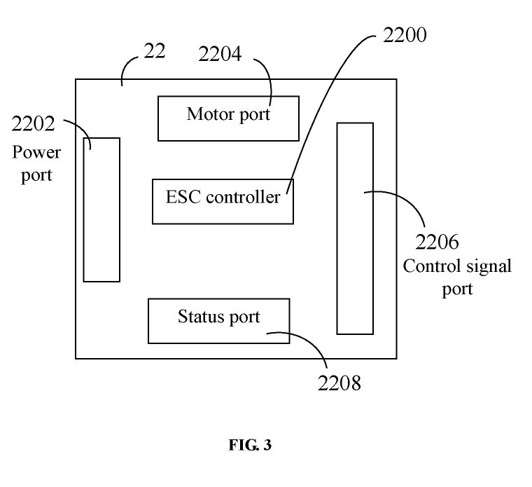

FIG. 3 is a block diagram of the ESC 22 according to an embodiment of the present disclosure. In some embodiments, the ESC 22 includes an ESC controller 2200, a power port 2202 configured to connect to a power source, a motor port 2204 configured to output the PWM signal, a control signal port 2206 configured to receive the control instructions from the control device 20, and a status port 2208 configured to share status information. The ESC controller 2200 may be configured to receive a control signal from the control signal port 2206, generate the PWM signal based on the control signal received, and output the PWM signal via the motor port 2204. The ESC controller 2200 may be a single-chip microcomputer, a digital processor, or another processor with a data processing function. The ESC 22 can be powered through the power port 2202. An input power to the ESC 22 is usually a direct current, such as power provided by a lithium battery. The motor port 2204 may output a three-phase pulsed direct current, which is connected to a three-phase input of the motor. In some embodiments, the status port 2208 may be a single I/O port, through which the status information of the ESC 22 can be output. The high-level output (such as about 5V) represents that the ESC 22 is in a normal state, while the low-level (such as about 0V) output indicates that the ESC 22 is in an abnormal state. In some embodiments, the status information may be shared among a plurality of ESCs 22. In other embodiments, the status information may be output to the control device 20. The status information of the ESC includes, but is not limited to, whether the ESC operation is abnormal, physical parameters of the ESC (e.g., temperature, current, voltage, and power, etc.) and so on.

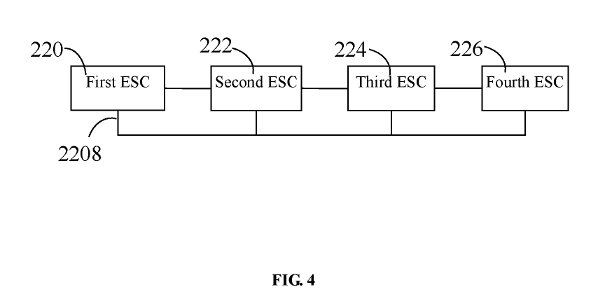

In some embodiments, the unmanned vehicle 1 may include a plurality of power mechanisms 12, and each of the plurality of power mechanisms 12 may correspond to an ESC 22 and a motor 24. In the description below, a four-rotor unmanned vehicle is described as an example. FIGS. 4-6 are schematic connection diagrams showing status information sharing among four ESCs 22. The ESCs 22 include a first ESC 220, a second ESC 222, a third ESC 224, and a fourth ESC 226. In some embodiments, as shown in FIG. 4, the status information is shared only between the ESCs 220-226, i.e., the status information may be output to other ESCs through mutual communication connections between the ESCs 220-226. When one of the ESCs 220-226 fails, the rest of the ESCs 220-226 may stop working, resulting in the corresponding motors stopping operation. The status ports 2208 of the ESCs 220-226 are connected only among the ESCs 220-226 and not to the control device 20. The ESC controller 2200 of an ESC 22 can obtain status information of that ESC 22 and status information of other ESCs 22 through its status port 2208 and control its operation according to the status information obtained. For example, when the status information of that ESC 22 or the status information of any other ESC 22 indicates that the corresponding ESC 22 is operating abnormally, the ESC controller 2200 may control the motor port to stop outputting the PWM signal or turn off the power supply of that ESC 22, so as to stop the motor 24 connected to that ESC 22.

In some embodiments, the status information output by the status port 2208 of the ESC 22 may be used to control a connection status between the control device 20 and the ESC 22. For example, when the status information output from the status port 220 of the ESC 22 indicates the status of the ESC is abnormal, the control device 20 is disconnected from the ESC 22 so that the ESC 22 stops operating.

In some other embodiments, the status information output by the status port 2208 of the ESC 22 can be used to control the connection status between the ESC 22 and the motor 24. For example, when the status information output by the status port 2208 of the ESC 22 indicates that the status of ESC 22 is abnormal, the ESC 22 may be disconnected from the motor 24, so that the motor 24 cannot receive the PWM signal from the ESC 22 and stops operating.

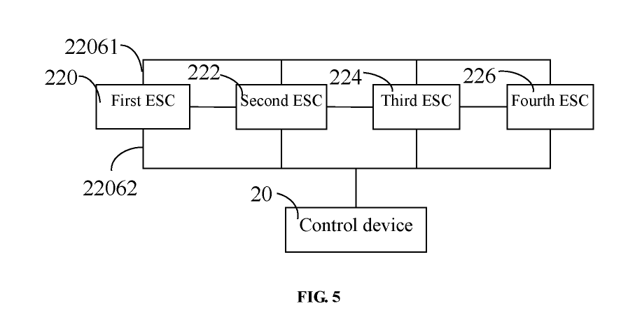

In some embodiments, as shown in FIG. 5, the status information may also be output to the control device 20. The status port includes a first communication port 22061 and a second communication port 22062. An ESC 22 is communicatively connected to other ESCs 22 via the first communication port 22061 such that the status information can be shared among the ESCs 220-226. An ESC 22 can output the status information to the control device 20 through the second communication port 22062. The first communication port 22061 and the second communication port 22062 may be configured independently, and may be a universal asynchronous receiver/transmitter (UART) bus, an inter-integrated circuit (I2C) bus, a serial peripheral interface (SPI), or a controller area network (CAN), etc. The control device 20 can adjust the control instructions for controlling the ESC 22 according to the status information. For example, in some embodiments, when the status information of the ESC 22 shows that the ESC 22 is in an abnormal status, the control device 20 can control the ESC 22 to stop working to avoid damage to the ESC 22 or the motor 24.

In some embodiments, the control signal port 2206 and the second communication port 22062 may be integrated as one communication port, through which the control device 20 can output a control signal to the ESC 22 and acquire the status information of the ESC 22 from the ESC 22. The communication mode between the ESC 22 and the control device 20 can be any appropriate wired connection such as serial connection or parallel connection. The wired connection includes any port connection, such as universal serial bus (USB), UART, CAN, I2C, serial, and/or another standard network connection. For example, for an I2C serial communication, each ESC 22 serves as a slave device, and the control device 20 serves as a master device. In some other embodiments, the ESC 22 and the control device 20 may be wirelessly connected, and status information of the ESC 22 is transmitted to the control device 20 through a wireless communication. The wireless communication includes, but are not limited to, Bluetooth, infrared, and/or wireless fidelity (Wi-Fi), etc.

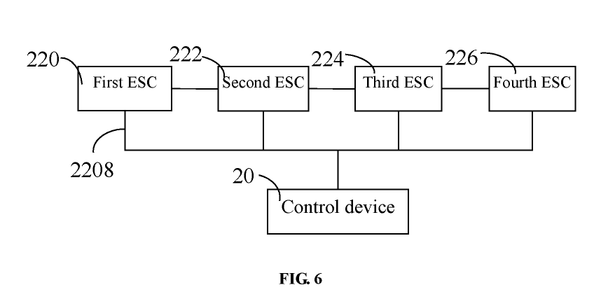

In some embodiment shown as FIG. 6, sharing of the status information is realized by the control device 20. The status port 2208 of each ESC 22 is communicatively connected to the control device 20. The control device 20 obtains the status information of each ESC 22 through the corresponding status port 2208 and controls the operation of the other ESCs 22 according to the status information. For example, when the status information of one of the ESCs 22 indicates that the operation of that ESC 22 is abnormal, the control device 20 controls all of the ESCs 22 to stop operating. Similar to the embodiments described above, in the embodiments described in connection with FIG. 6, the control signal port 2206 and the status port 2208 may be integrated as one communication port. Through the communication port, the control device 20 outputs a control signal to the ESC 22 and acquires the status information of the ESC 22 from the ESC 22.

In some embodiments, the control device 20 may also obtain the operating information of the motor 24 connected to the ESC 22 through the status port 2208. The operating information of the motor may include, but is not limited to, physical property parameters of the motor (e.g., temperature, current, and voltage, power, etc.), physical properties of electronic components (e.g., motor resistance, and motor inductance, etc.) of the motor, information detected by sensors of the motor and so on.

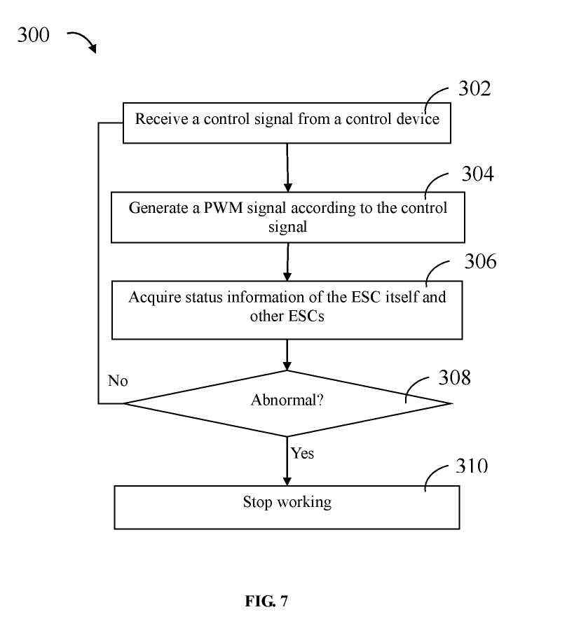

FIG. 7 is a flowchart of an ESC control method 300 according to an embodiment of the present disclosure. According to different requirements, the order of the processes in the flowchart may be changed, and one or more processes may be omitted or merged.

302: An ESC 22 receives a control signal from a control device 20.

304: The ESC 22 generates a PWM signal according to the control signal received, and outputs the PWM signal to a motor 24 through a motor port 2204.

306: The ESC 22 acquires status information of itself and other ESCs 22 through a status port 2208.

308: The ESC 22 determines whether one or a plurality of ESCs 22 are abnormal according to the status information of itself and other ESCs 22. If yes, S310 is executed, and if not, the process returns to S302.

310: The ESC 22 stops working. The ESC 22 is disconnected from a power supply or the motor 24, so that the ESC 22 stops outputting the PWM signal to the motor 24 and the motor 24 stops operating.

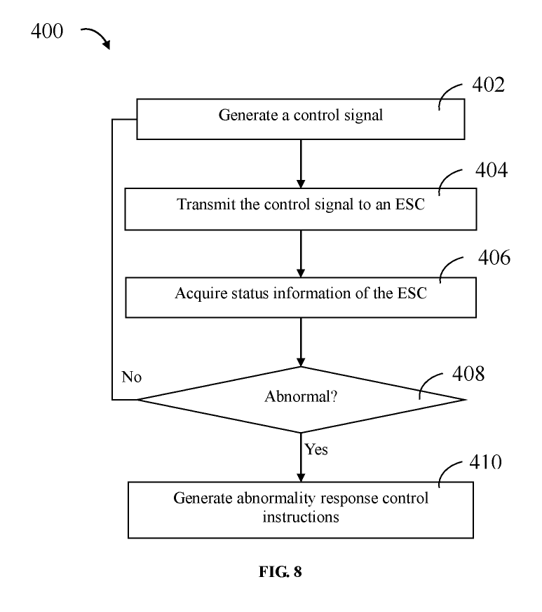

FIG. 8 is a flowchart of an unmanned vehicle control method 400 according to another embodiment of the present disclosure. According to different requirements, the order of the processes in the flowchart may be changed, and one or more processes may be omitted or combined.

402: A control device 20 generates a control signal. The control device 20 generates the control signal according to the control instructions received by a transceiver 16 and current status data of the unmanned vehicle 1 generated by a sensing system 14. The control signal is transmitted to an ESC 22.

404: The control device 20 transmits the control signal to the ESC 22. The ESC 22 generates a PWM signal according to the control signal. The PWM signal is transmitted to a motor 24 connected to the ESC 22 to control the rotation of a rotor of the motor 24, so as to drive a power mechanism 12 to rotate.

406: The control device 20 acquires status information of the ESC 22, and the status information includes a signal indicating whether the ESC 22 is working properly. In some other embodiments, the status information may also include temperature, voltage, current, and output power, etc., of the ESC 22.

408: The control device 20 determines whether the ESC 22 is in an abnormal status according to the status information of the ESC 22. If the ESC 22 is in the abnormal state, S410 is executed, while if not, the process returns to S402.

410: The control device 20 generates abnormality response control instructions according to the abnormal state. For example, when the hardware failure of the ESC 22, abnormality of the motor, rotor stalling, and/or no-load (shooting) influence the operation of the unmanned vehicle 1, the control device 20 may generate control instructions to control other ESCs 22 to stop working to avoid a secondary damage.

In some other embodiments, S408 and S410 may also be that the ESC 22 determines whether there is an abnormality in the ESC according to the status information of the other ESCs 22, and when one of the ESCs 22 is abnormal, all of the ESCs 22 stop working to avoid a secondary damage.

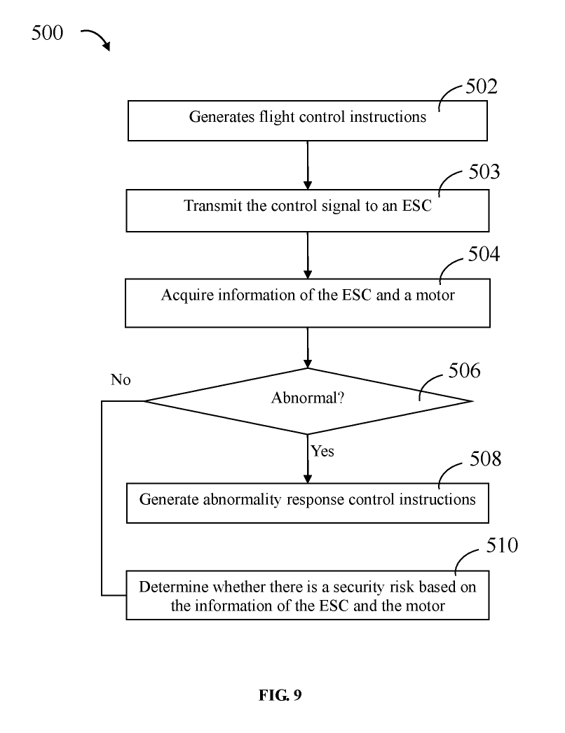

FIG. 9 is a flowchart of an unmanned vehicle control method 500 of another embodiment of the present disclosure. According to different requirements, the order of the processes in the flowchart may be changed, and one or more processes may be omitted or combined.

502: A control device 20 generates flight control instructions. The control device 20 generates a control signal according to the control instructions received by a transceiver 16 and current status data of an unmanned vehicle 1 generated by a sensing system 14. The control signal is transmitted to an ESC 22.

503: The control device 20 transmits the control signal to the ESC 22. The ESC 22 generates a PWM signal according to the control signal. The PWM signal is transmitted to a motor 24 connected to the ESC 22 to control the rotation of the motor 24, so as to drive a power mechanism 12 to rotate.

504: The control device 20 acquires information of the ESC and the motor 24. The information of the ESC 22 may include, but is not limited to, physical properties of the ESC 22, such as temperature, voltage, current, power, and so on. The information of the motor 24 may include, but is not limited to, physical properties of the motor, such as temperature, current, voltage, power, and so on, and physical properties of electronic components (e.g., resistors, and inductors, etc.) within the motor 24.

506: The control device 20 determines whether the ESC 22 is abnormal based on the information of the ESC 22. If the ESC 22 is abnormal, S508 is executed, and if not, S510 is executed.

508: The control device 20 generates abnormality response control instructions. For example, when the hardware failure of the ESC 22, abnormality of the motor, rotor stalling, and/or no-load (shooting) influence the operation of the unmanned vehicle 1, the control device 20 may generate control instructions to control other ESCs 22 to stop working to avoid a secondary damage.

510: The control device 20 determines whether there is a security risk based on the information of the ESC and the motor, for example, whether the temperature of the ESC 22 and/or the motor 24 is close to a specified maximum temperature, and/or whether the voltage or current of the ESC 22 and/or the motor 24 is close to a limit value.

It is intended that the specification and embodiments be considered as examples only and not to limit the scope of the disclosure. Any modification and equivalently replacement for the technical solution of the present disclosure should all fall in the spirit and scope of the technical solution of the present disclosure.

What is claimed is:

1. A control system comprising:
a control device configured to generate a control signal based on control instructions received by a transceiver;
a plurality of electronic speed controls (ESCs) communicating and sharing status information with each other, each of the plurality of ESCs being configured to generate a driving signal based on the control instructions; and
a plurality of motors each coupled to one of the plurality of ESCs and driven by the driving signal generated by the one of the plurality of ESCs.

2. The control system according to claim 1, wherein the status information of one of the plurality of ESCs includes whether the one of the plurality of ESCs is operating abnormally.

3. The control system according to claim 1, wherein each of the plurality of ESCs includes a status port configured to share the status information of the each of the plurality of ESCs.

4. The control system according to claim 3, wherein the status ports of the plurality of ESCs are connected to each other for sharing the status information among the plurality of ESCs.

5. The control system according to claim 4, wherein the plurality of ESCs are configured to stop operating in response to one of the plurality of ESCs being operating abnormally.

6. The control system according to claim 3, wherein:
the status port of each of the plurality of ESCs is communicatively connected to the control device; and
the plurality of ESCs are configured to share the status information among each other through communicating with the control device.

7. The control system according to claim 6, wherein the control device is configured to obtain the status information of the plurality of ESCs and output the control signal through the status ports of the plurality of ESCs.

8. The control system according to claim 6, wherein the control device is configured to control the plurality of ESCs to stop operating in response to one of the plurality of ESCs is operating abnormally.

9. The control system according to claim 8, wherein the one of the plurality of ESCs operating abnormally includes at least one of a hardware failure of the one of the plurality of ESCs, an abnormality of the motor coupled to the one of the plurality of ESCs, stalling, or no-load.

10. The control system according to claim 3, wherein:
the status port of one of the plurality of ESCs includes a first communication port and a second communication port;
the one of the plurality of ESCs is configured to share the status information with other ones of the plurality of ESCs through the first communication port; and
the control device is configured to obtain the status information of the one of the plurality of ESCs through the second communication port.

11. The control system according to claim 10, wherein the first communication port and second communication port are configured independently.

12. The control system according to claim 10, wherein the first communication port and the second communication port are serial bus ports.

13. The control system according to claim 1, wherein the control device is communicatively connected to the plurality of ESCs and is configured to obtain the status information of the plurality of ESCs and information of the plurality of motors.

14. The control system according to claim 13, wherein the information of the plurality of motors includes at least one of physical properties of the plurality of motors or information detected by sensors of the plurality of motors.

15. The control system according to claim 13, wherein the control device is communicatively connected to the plurality of ESCs through a wired or wireless connection.

16. A control method comprising:
generating, by a control device, a control signal based on control instructions received by a transceiver;
transmitting, by the control device, the control signal to one or more of a plurality of electronic speed controls (ESCs);
determining, by the control device, whether the plurality of ESCs are operating abnormally based on status information of the plurality of ESCs; and
controlling, by the control device, the plurality of ESCs to stop operating in response to detecting that at least one of the plurality of the ESCs is operating abnormally.

17. The control method according to claim 16, further comprising:
obtaining, through the plurality of ESCs, information of a plurality of motors each connected to one of the plurality of ESCs; and
determining, in response to determining that the plurality of ESCs are operating normally, whether a security risk exists based on the status information of the plurality of ESCs and the information of the plurality of motors.

18. The control method according to claim 17, wherein:
the status information of the plurality of ESCs includes physical properties of the plurality of ESCs;
the information of the plurality of motors includes physical properties of the plurality of motors; and
determining whether the security risk exists includes determining that the security risk exists in response to detecting that any one of the physical properties of the plurality of ESCs and the plurality of motors reaches a predetermined limit value.

19. The control method according to claim 18, wherein the physical properties of the plurality of ESCs and the physical properties of the plurality of motors include at least one of temperature, electric current, voltage, or power.

20. The control method according to claim 16, wherein determining whether the plurality of ESCs are operating abnormally includes determining whether at least one of hardware failure of the plurality of ESCs, an abnormality of the plurality of motors, stalling, or no-load occurs.
